(19) United States
(12) Patent Application Publication
(10) Pub. No.: US 2011/0095667 A1
(43) Pub. Date: Apr. 28, 2011

(54) DESK DRAWER FACE CONVERTER MODULE

(76) Inventors: Jamie Toland, Russellville, AR (US); John Gregory, Enola, AR (US); Will Embry, Morrilton, AR (US)

(21) Appl. No.: 12/606,858

(22) Filed: Oct. 27, 2009

(51) Int. Cl. A47B 88/00; B23P 23/00

(52) U.S. Cl. 312/348.4; 29/401.1

(57) ABSTRACT

The invention is a drawer face converter module for converting a flush mount desk drawer to an overlapping desk drawer. The desk drawer is disposed in a drawer opening having a width and a height. The drawer face converter module includes (i) a forward portion having a width which is between about ½ inch and about 1 inch greater than the width of the drawer opening and a height which is between about ½ inch and about 1 inch greater than the height of the drawer opening, and (ii) a rearward portion having a width between about 1/16 inch and about 1/4 inch less than the width of the drawer opening, a height between about 1/16 inch and about ¼ inch less than the height of the drawer opening and a depth between about ⅛ inch and about 1 inch.

### BACKGROUND OF THE INVENTION

Desk drawers, especially metal desk drawers, frequently come in one of two styles: a flush mount face and an overlapping face.

It is not uncommon for a user to convert desks having flush mount drawer faces to a desk having overlapping desk drawer faces. However, this has heretofore been difficult, complicated and expensive to do. Converting a prior art desk drawer face from a flush mount face-type to an overlapping face-type has typically required the complete restructure of the desk and drawer, including relocating the desk drawer suspension mechanisms.

Accordingly, there is a need for a desk drawer face converter module which will simplify and make less expensive the conversion from a flush mount desk drawer face to an overlapping desk drawer face.

### SUMMARY OF THE INVENTION

The invention satisfies this need. The invention is a drawer face converter module for converting a flush mount desk drawer to an overlapping desk drawer. The desk drawer is disposed in a drawer opening having a width and a height. The drawer face converter module comprises (i) a forward portion having a width which is between about ½ inch and about 1 inch greater than the width of the drawer opening and a height which is between about ½ inch and about 1 inch greater than the height of the drawer opening, and (ii) a rearward portion having a width between about 1/16 inch and about ¼ inch less than the width of the drawer opening, a height between about 1/16 inch and about ¼ inch less than the height of the drawer opening and a depth between about ⅛ inch and about 1 inch.

### DRAWINGS

These and other features, aspects and advantages of the present invention will become better understood with reference to the following description, appended claims and accompanying drawings where:

FIG. 1 is a perspective view of a desk having drawers with flush mount drawer faces;

FIG. 2 is a perspective view of a drawer disposed within the desk illustrated in FIG. 1;

FIG. 3 is a drawer face converter module having features of the invention;

FIG. 4 is a reverse perspective view of the drawer face converter module illustrated in FIG. 3;

FIG. 5 is a top view of the drawer face converter module illustrated in FIG. 4 taken along line 5-5;

FIG. 6 is a cross-sectional view of a portion of the drawer face converter module illustrated in FIG. 4 taken along line 6-6;

FIG. 7 is a side view of the drawer face converter module illustrated in FIG. 4 taken along line 7-7;

FIG. 8 is a cross-sectional view of the drawer face converter module illustrated in FIG. 4 taken along line 8-8;

FIG. 9 is an exploded view of the desk drawer illustrated in FIG. 2 showing the removal of its desk drawer face;

FIG. 10 is a perspective view of the drawer illustrated in FIG. 9 showing the installation of a drawer face converter module illustrated in FIGS. 6 and 7; and

FIG. 11 is a perspective view of the partial desk illustrated in FIG. 1 showing the conversion of its desk drawers from flush mount style to overlapping style.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a drawer face converter module 10 for converting a flush mount desk drawer 12 to an overlapping desk drawer 12.

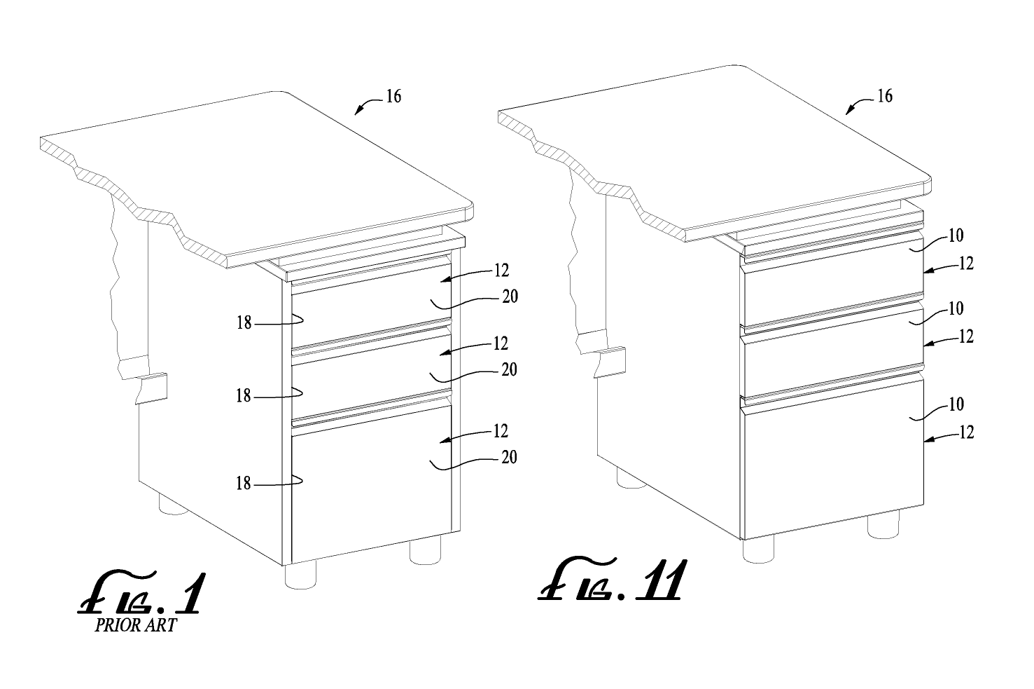

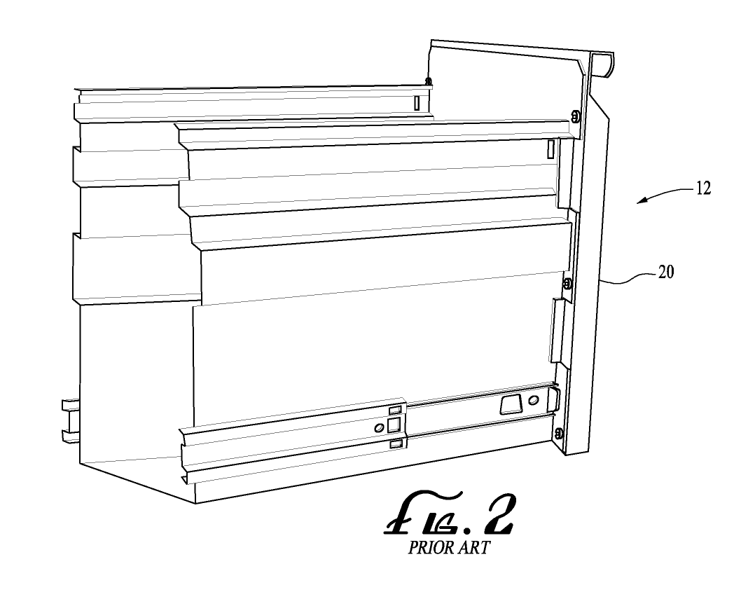

FIG. 1 illustrates a prior art desk 16 having three flush mount desk drawers 12, each desk drawer 12 is disposed in a drawer opening 18 having a width and a height. FIG. 2 is a side view of the larger of these three desk drawers 12.

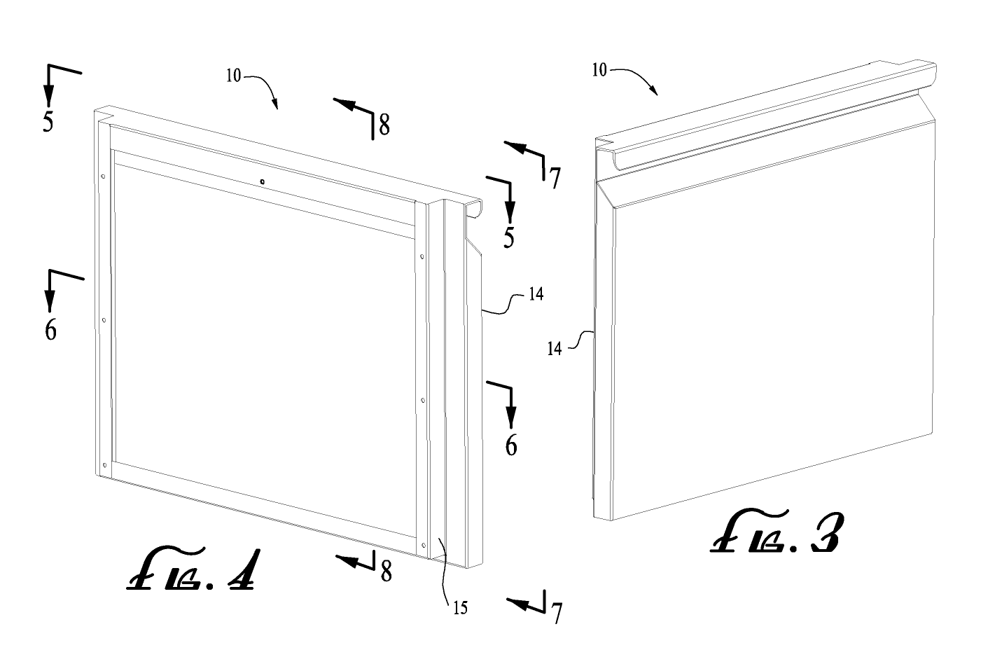

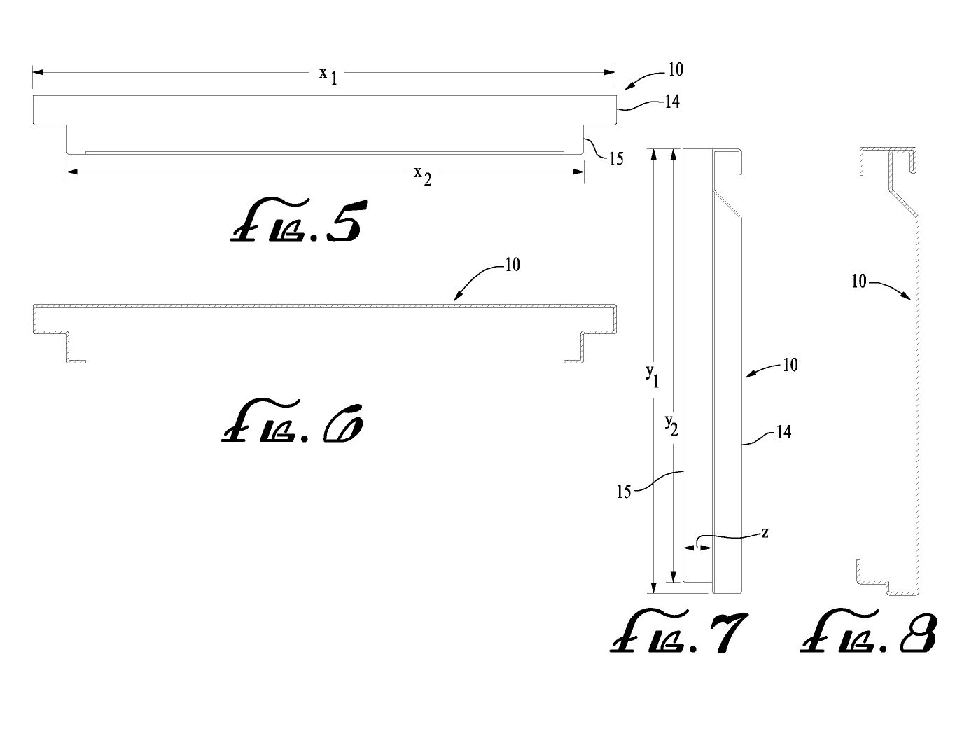

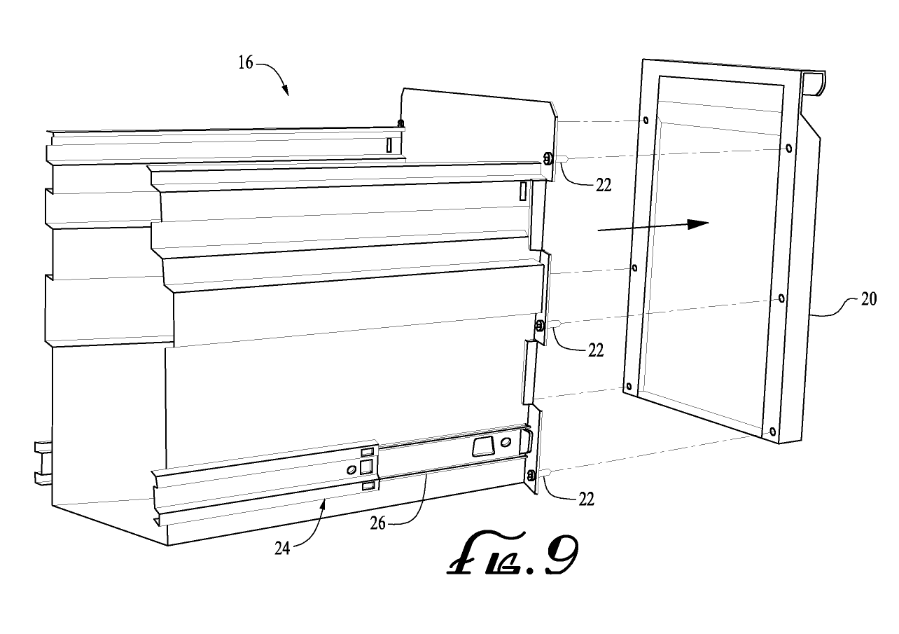

The drawer face converter module 10 is illustrated in FIGS. 3-8. The drawer face converter module 10 has a forward portion 14 with a width w₁ which is between about ½ inch and about 1 inch greater than the width of the drawer opening 18 and a height h₁ which is between about ½ inch and about 1 inch greater than the height of the drawer opening 18. The drawer face converter module 10 also has a rearward portion 15 with a width w₂ between about 1/16 inch and about ¼ inch less than the width of the drawer opening 18, a height h₂ between about 1/16 inch and about ¼ inch less than the height of the drawer opening 18 and a depth d between about ⅛ inch and about 1 inch.

The drawer face converter module 10 can be used to convert a desk 16 having flush mount drawers 12, such as the desk 16 illustrated in FIG. 1, to a desk 16 having overlapping desk drawers 12, such as the desk 16 illustrated in FIG. 11. A typical desk drawer 12 having a conventional flush mount drawer face 20 is illustrated in FIG. 2. The flush mount drawer face 20 is attached to the drawer 12 by attachment screws 22. The drawer 12 is suspended within a drawer opening 18 by a suspension system 24 comprising oppositely disposed suspension members 26.

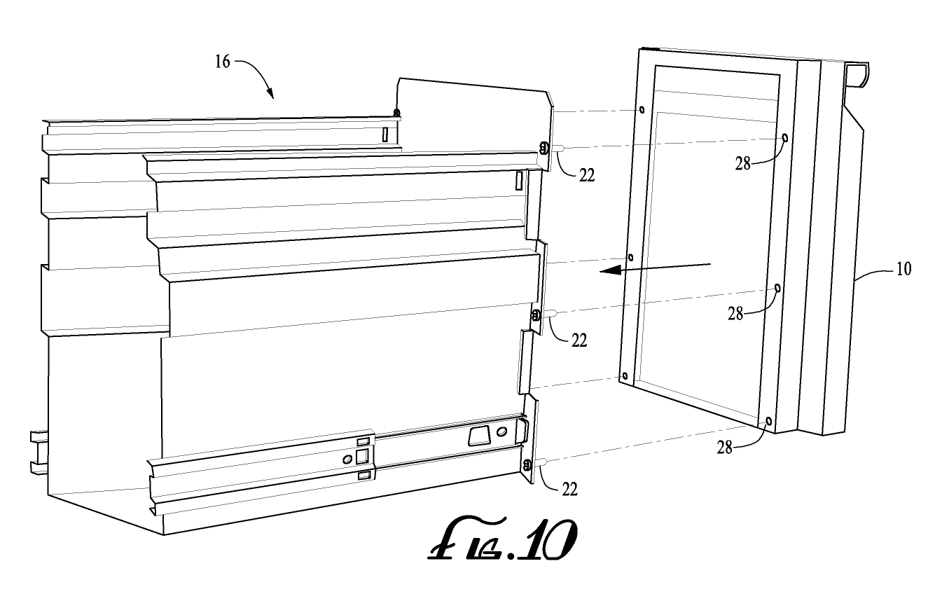

In the invention, the conventional flush mount drawer face 20 is removed from the drawer 12 as illustrated in FIG. 9, and the drawer face converter module 10 is then attached to the drawer 12 as illustrated in FIG. 10. Preferably, the drawer face converter module 10 is provided with screw openings 28 which match up with the existing drawer face attachment screws 22.

By this method, the flush mount desk 16 illustrated in FIG. 1 can be easily and efficiently converted to an overlapping desk drawer 12, as illustrated in FIG. 11. In the desk 16 illustrated in FIG. 11, the rearward portion 15 of the drawer face converter module 10 is disposed within the drawer opening 18, while the forward portion 14 of the drawer face converter module 10 overlaps the exterior of the desk 16. In a conversion from a flush mount drawer 12 to an overlapping drawer 12 using the drawer face converter module 10, the drawer suspension members 26 need not be replaced nor reinstalled. The drawer suspension members 26 are conveniently left in place, attached to the sides of the drawer 12.

Having thus described the invention, it should be apparent that numerous structural modifications and adaptations may be resorted to without departing from the scope and fair meaning of the instant invention as set forth hereinabove.

What is claimed is:

1. A drawer face converter module for converting a flush mount desk drawer to an overlapping desk drawer, wherein the desk drawer is disposed in a drawer opening having a width and a height, the drawer face converter module comprising (i) a forward portion having a width which is between about ½ inch and about 1 inch greater than the width of the drawer opening and a height which is between about ½ inch and about 1 inch greater than the height of the drawer opening, and (ii) a rearward portion having a width between about 1/16 inch and about ¼ inch less than the width of the drawer opening, a height between about 1/16 inch and about ¼ inch less than the height of the drawer opening and a depth between about ⅛ inch and about 1 inch.

2. A desk having a desk drawer with an overlapping drawer face converter module, the desk drawer being disposed in a drawer opening within the desk, the drawer opening having a width and a height, the drawer face converter module comprising (i) a forward portion having a width which is between about ½ inch and about 1 inch greater than the width of the drawer opening and a height which is between about ½ inch and about 1 inch greater than the height of the drawer opening, and (ii) a rearward portion having a width between about 1/16 inch and about ¼ inch less than the width of the drawer opening, a height between about 1/16 inch and about ¼ inch less than the height of the drawer opening and a depth between about ⅛ inch and about 1 inch.

3. A method for converting a desk drawer having a flush mount drawer face to a desk drawer having an overlapping drawer face, wherein the desk drawer is suspended within a drawer opening in the desk by a pair of oppositely disposed suspension members attached to opposite sides of the drawer, the drawer opening having a width and a height, the method comprising:
(a) providing a drawer face converter module having (i) a forward portion having a width which is between about ½ inch and about 1 inch greater than the width of the drawer opening and a height which is between about ½ inch and about 1 inch greater than the height of the drawer opening, and (ii) a rearward portion having a width between about 1/16 inch and about ¼ inch less than the width of the drawer opening, a height between about 1/16 inch and about ¼ inch less than the height of the drawer opening and a depth between about ⅛ inch and about 1 inch;
(b) removing the flush mount drawer face from the drawer;
(c) attaching the drawer face converter module to the drawer while leaving in place the drawer suspension members attached to the sides of the drawer.
